(19) United States
(12) Patent Application Publication
(10) Pub. No.: US 2008/0005233 A1
(43) Pub. Date: Jan. 3, 2008

(54) ONLINE CONFERENCING SYSTEMS FOR SHARING DOCUMENTS

(76) Inventors: Yigang Cai, Naperville, IL (US); Alexander Aihao Yin, QingDao (CN)

Correspondence Address: DUFT BORNSEN & FISHMAN, LLP, 1526 SPRUCE STREET, SUITE 302, BOULDER, CO, 80302, US

(21) Appl. No.: 11/427,670

(22) Filed: Jun. 29, 2006

(51) Int. Cl. G06F 15/16

(52) U.S. Cl. 709/204

(57) ABSTRACT

Online conferencing systems and methods are disclosed that provide for sharing of documents in a more efficient manner during an online conference. A document to be shared is transmitted to each of the participants of an online conference through a conference server. If one of the participants navigates through the document using an application, then a client conferencing system installed on the device of the participant detects navigation instructions in the application and reports the navigation instructions to the conference server. The conference server then reports the navigation instructions to the other participants of the online conference. The corresponding application on the devices of the other participants receives the navigation instructions and operates according to the instructions to synchronize viewing of the document among the participants.

### BACKGROUND OF THE INVENTION

1. Field of the Invention

The invention is related to the field of conferencing systems, and in particular, to online conferencing systems that provide improved collaboration of documents among participants of an online conference.

2. Statement of the Problem

Internet conferencing tools allow individuals and businesses to initiate an online conference among participants that are remote from one another. Many of today's online conferences require sharing of documents among the conference participants for presentation of the documents during the online conference. Traditionally, the host of the online conference distributes the documents to the other participants before the online conference starts so that they can be printed or downloaded by the other participants. During the online conference, the host tells the other participants in the online conference which page to turn to in the document during the presentation.

Some of the internet conferencing tools also include document collaboration tools that allow documents to be presented to the participants in a synchronized manner. One type of document collaboration tool, such as NetMeeting, clones a desktop image of the host's PC and distributes the desktop image to the PCs of the other participants. As an example, if the host is presenting a document on his/her PC, then the document collaboration tool clones the desktop image being displayed on the host's PC and transmits the desktop image to the other participants in the online conference. The PCs of the other participants can then display the desktop image of the host's PC so that all of the participants are viewing the same image of the document. If the host switches to another page of the document, then the online collaboration tool again clones the desktop image and transmits the new desktop image to the other participants for display on their PCs. If the host switches to yet another page of the document, then the online collaboration tool again clones the desktop image for a third time and transmits the new desktop image to the other participants for display on their PCs. One problem with this type of collaboration is that it consumes a lot bandwidth and time to transmit the desktop image to the other participant's PCs each time a new image is displayed on the host's PC.

Another type of document collaboration tool, such as WebX or LiveMeeting, enables web collaboration via a centralized conference server deployed on the Internet. If the host is presenting a document on his/her PC, then the document collaboration tool converts the format of the document to an image format that can be recognized by a browser (i.e., Internet Explorer) on the other participant's PCs. For example, the LiveMeeting tool converts documents to a Live Meeting format (.lmp). The document collaboration tool then uploads the converted document to the conference server. The other participants may then view the document through their browser on their PCs over the Internet.

There are problems providing online collaboration in this manner. First, by converting the documents to image files, moving picture content (e.g., PPT customized animation, moving GIF, etc) cannot be displayed to the other participants. Secondly, there is an increased risk of the important business secrets being disclosed because these documents are uploaded and shared via public internet access. Third, the quality of the conference voice and video can't be guaranteed when transmitting over the Internet.

Some online conference tools also provide dedicated equipment to mix the collaboration data into the conference voice path to share among the participants' PCs, such as Polycom's “Voice+Content” solution. Unfortunately, this solution requires that each conference location has this dedicated equipment installed and connected to the conference endpoints. Using this dedicated equipment can be costly to install, and can be inconvenient as the participants have to gather in a location where the dedicated equipment is installed.

### SUMMARY OF THE SOLUTION

The invention solves the above and other related problems with improved online conferencing systems and methods.

An online conferencing system as provided herein includes a conference server and client conferencing systems that are installed in devices of the participants of an online conference. The client conferencing systems include a conference portal and a document navigation system. The conference portal is adapted to communicate with the conference server to join a participant in the online conference. If the participant wants to share a document with other participants of the online conference, then the conference portal is adapted to transmit the document to the conference server (and the conference server transmits the document to the other participants). The document navigation system is adapted to launch an application to open the document to be shared so that the participant may view the document. The document navigation system is further adapted to detect a navigation instruction from the participant in the application for navigating through the document, and to transmit the navigation instruction to the conference portal. The conference portal is further adapted to transmit the navigation instruction to the conference server.

The conference server includes a document control system and a navigation control system. The document control system is adapted to receive the document from the conference portal that is to be shared with other participants of the online conference, and to transmit the document to the other participants. The navigation control system is adapted to receive the navigation instruction from the conference portal, and to transmit the navigation instruction to the other participants to synchronize viewing of the document among the participants.

The conference portal of a client conferencing system is further adapted to receive the navigation instruction from the conference server, and transmit the navigation instruction to the document navigation system. The document navigation system is further adapted to provide the navigation instruction to the application to navigate through the document. Each of the participants is thus viewing the same page or image in the document.

The online conference system as described herein provides many advantages over prior online conferencing tools. First, the document navigation system/conference portal reports navigation instructions to the conference server instead of providing a desktop image as is done with some prior online conferencing tools. The data size of a navigation instruction is smaller than the data size of a desktop image, which saves bandwidth on the communication network connecting the participants of the online conference. Also, the smaller navigation instructions may be transmitted faster over the communication network than the desktop images, which results in less delay in synchronizing the pages of the document among the participants. Secondly, the document does not have to be converted to an image format before being transmitted to the conference server as is done with some prior online conferencing tools. Documents with moving effects, such as customized animation, moving GIF, etc, can be preserved.

The invention may include other exemplary embodiments described below.

### DESCRIPTION OF THE DRAWINGS

The same reference number represents the same element or same type of element on all drawings.

FIG. 1 illustrates an online conferencing system in an exemplary embodiment of the invention.

FIG. 2 is a message diagram illustrating an exemplary online conference in an exemplary embodiment of the invention.

FIG. 3 illustrates an online conferencing system in another exemplary embodiment of the invention.

### DETAILED DESCRIPTION OF THE INVENTION

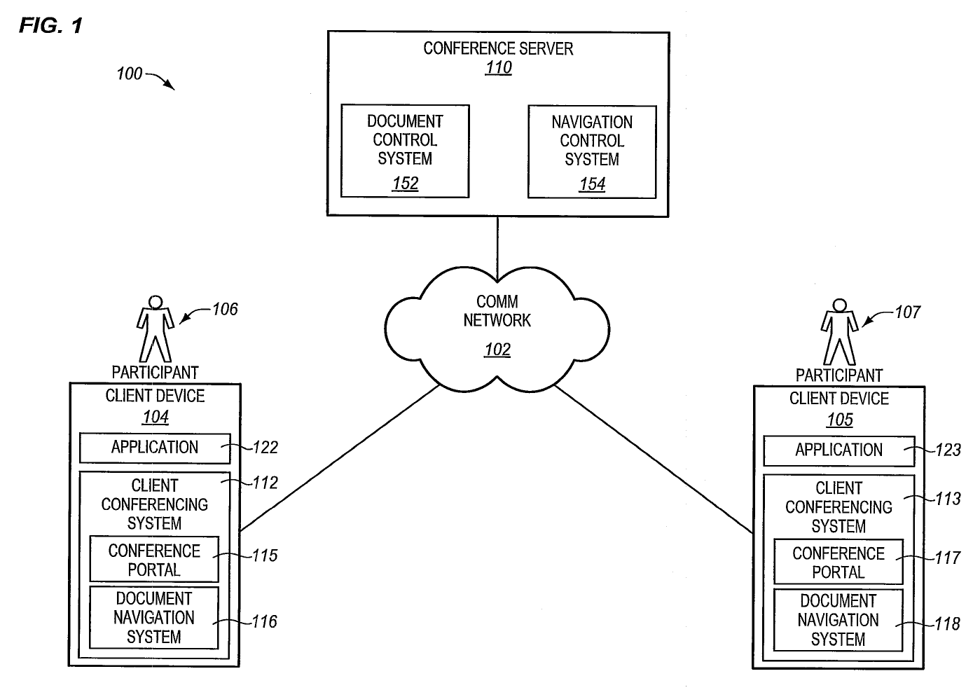

FIGS. 1-3 and the following description depict specific exemplary embodiments of the invention to teach those skilled in the art how to make and use the invention. For the purpose of teaching inventive principles, some conventional aspects of the invention have been simplified or omitted. Those skilled in the art will appreciate variations from these embodiments that fall within the scope of the invention. Those skilled in the art will appreciate that the features described below can be combined in various ways to form multiple variations of the invention. As a result, the invention is not limited to the specific embodiments described below, but only by the claims and their equivalents.

FIG. 1 illustrates an online conferencing system 100 in an exemplary embodiment of the invention. Online conferencing system 100 includes a conference server 110 and client conferencing systems 112-113. Client conferencing systems 112-113 connect to conference server 110 over a communication network 102. Communication network 102 may comprise a packet-based network configured to provide voice and data communications, such as an IP network, an IP Multimedia Subscriber (IMS) network, or any other type of network. Communication network 102 may be a private IP network, such as an enterprise intranet.

Online conferencing system 100 is adapted to provide online conferencing services and document collaboration to a plurality of participants. Participant 106 is operating client device 104 and participant 107 is operating client device 105. Client devices 104-105 may comprise computers (PCs), phones, etc. Those skilled in the art understand that online conferences may include multiple other participants not shown in FIG. 1.

Conference server 110 is a system that sets up, manages, and tears-down online conferences. Conference server 110 includes a document control system 152 and a navigation control system 154.

Client conferencing system 112 is operating on client device 104. Client conferencing system 113 is operating on client device 105. Client conferencing systems 112-113 comprise any software, code, or application adapted to provide online conference functionality at the client side of an online conference. Client conferencing system 112 includes a conference portal 115 and a document navigation system 116. Similarly, client conferencing system 113 includes a conference portal 117 and a document navigation system 118. A conference portal comprises an interface to an online conferencing service. A document navigation system comprises any system or software adapted to detect navigation instructions performed by an application on a document, and report the navigation instructions. A document navigation system may comprise plug-in software that is embedded in an operating system operating on client devices 104-105, respectively. For instance, client device 104 may be operating Microsoft Office or another type of operating system that includes a plurality of applications, such as Word, PowerPoint, Excel, etc. A document navigation system may comprise plug-in software for Microsoft Office that is able to interface with the applications operating in Microsoft Office.

To initiate an online conference between participant 106 and participant 107, the participants first register with conference server 110. To register, conference portal 115 transmits a registration message to conference server 110 over communication network 102 to join participant 106 in the online conference. Similarly, conference portal 117 transmits a registration message to conference server 110 over communication network 102 to join participant 107 in the online conference. Conference server 110 registers client conferencing system 112 and client conferencing system 113 for the online conference. Conference server 110 may also provide parameters or other information to client conferencing systems 112-113 for the online conference.

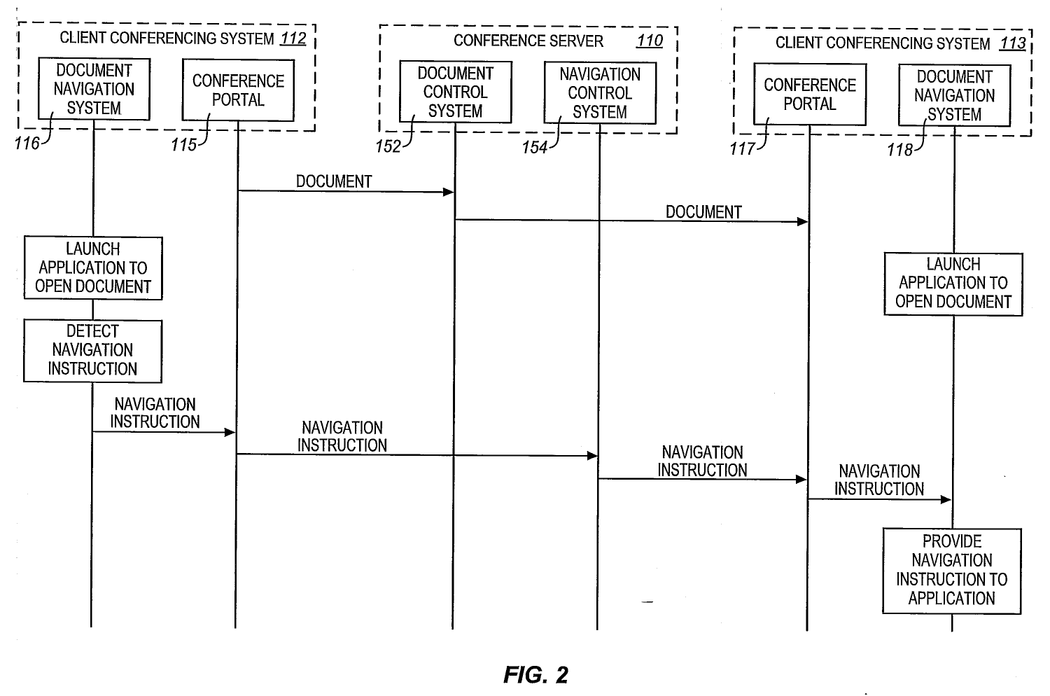

Assume for this embodiment that participant 106 wants to share a document with participant 107 of the online conference. FIG. 2 is a message diagram illustrating an exemplary online conference in an exemplary embodiment of the invention. Participant 106 instructs conference portal 115 to transmit the document to be shared to conference server 110 over communication network 102. Document control system 152 in conference server 110 receives and stores the document. Document control system 152 transmits the document to the other participants of the online conference, which means that document control system 152 transmits the document to client conferencing system 113. Conference portal 117 receives the document and temporarily stores the document on client device 105.

Document navigation system 116 on client device 104 launches the appropriate application 122 to open the document in client device 104 that can be viewed by participant 106. For instance, if the document is a PowerPoint document, then document navigation system 116 may launch the PowerPoint application to open the document. Similarly, document navigation system 118 on client device 105 launches the appropriate application 123 to open the document in client device 105 that can be viewed by participant 107.

During the online conference, participant 106 may navigate through the document using application 122. For instance, if the document is a PowerPoint document, then participant 106 may initiate a slide show or may manually navigate forward or backward through the slides of the document. According to features and aspects herein, document navigation system 116 detects a navigation instruction from participant 106 in application 122 for navigating through the document. A navigating instruction comprises a command, keystroke, or other input that navigates through the document. As an example, the navigation instruction may be a “Next Page” command in a PowerPoint application. Document navigation system 116 transmits the navigation instruction (or some indication of the navigation instruction) to conference portal 115. Conference portal 115 transmits the navigation instruction to conference server 110 over communication network 102.

Navigation control system 154 in conference server 110 receives the navigation instruction and transmits the navigation instruction to the other participants of the online conference, which means that navigation control system 154 transmits the navigation instruction to conference portal 117. Conference portal 117 transmits the navigation instruction to document navigation system 118. Document navigation system 118 then provides the navigation instruction to application 123 to synchronize viewing of the document with application 122. As an example, if the navigation instruction is a “Next Page” command in a PowerPoint application, then document navigation system 118 provides the “Next Page” command to the PowerPoint application to cause the PowerPoint application to navigate to the next page of the document.

Document navigation system 116 continually detects navigation instructions in application 122 and conference portal 115 reports the navigation instructions to conference server 110. Conference server 110 in turn reports the navigation instructions to conference portal 117, which in turn reports the navigation instructions to document navigation system 118. Document navigation system 118 then provides the navigation instructions to application 123 so that all of the participants of the online conference can view the same pages of the document.

Online conferencing system 100 as described herein provides many advantages over prior online conferencing tools. First, document navigation system 116/conference portal 115 reports navigation instructions to conference server 110 instead of providing a desktop image as is done with some prior online conference tools. The navigation instructions may be 100 bytes or less whereas the desktop image may be 500 kilobytes or more, which saves bandwidth on communication network 102. Also, the smaller navigation instructions may be transmitted faster over communication network 102 than the desktop images, which results in less delay in synchronizing the pages of the document among participants 106-107. For instance, the delay from transmitting the navigation instructions may be less than 0.1 seconds while the delay from transmitting desktop images may be one to two seconds. Secondly, the document does not have to be converted to an image format before being transmitted to conference server 110 as is done with some prior online conferencing tools. Documents with moving effects, such as PPT customized animation, moving GIF, etc, can be preserved.

In FIG. 1, control over navigation of the document may change among participants 106-107 of the online conference. For instance, if participant 107 wants to control navigation through the document, then conference portal 117 transmits a navigation control request to conference server 110 responsive to an instruction from participant 107. Navigation control system 154 receives the navigation control request, and transmits a navigation control command to conference portal 117. Navigation control system 154 may also transmit a navigation control command to other conference portals.

Document navigation system 118 then detects a navigation instruction from participant 107 in application 123 for navigating through the document. Document navigation system 118 transmits the navigation instruction (or some indication of the navigation instruction) to conference portal 117. Conference portal 117 transmits the navigation instruction to conference server 110 over communication network 102. Navigation control system 154 receives the navigation instruction and transmits the navigation instruction to the other participants of the online conference, which means that navigation control system 154 transmits the navigation instruction to conference portal 115. Conference portal 115 transmits the navigation instruction to document navigation system 116. Document navigation system 116 then provides the navigation instruction to application 122 to synchronize viewing of the document with application 123.

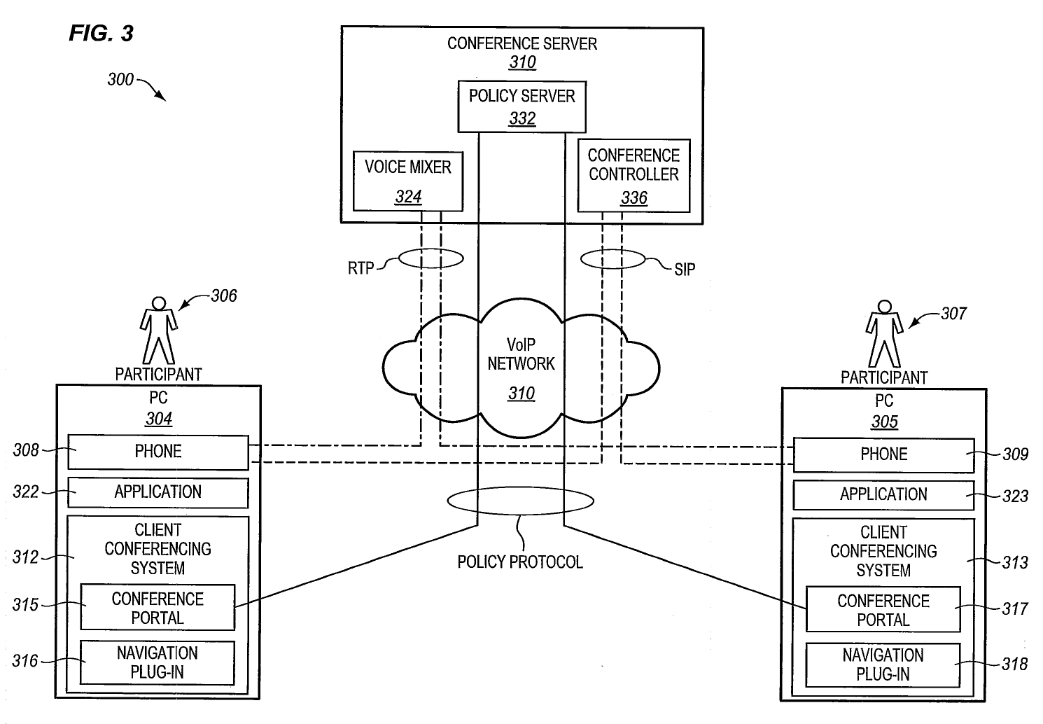

FIG. 3 illustrates an online conferencing system 300 in another exemplary embodiment of the invention. Online conferencing system 300 is adapted to provide an online conferencing service to a plurality of participants, such as participants 306-307. Participant 306 is operating a PC 304 that includes a softphone 308. Participant 306 is operating a PC 305 that includes a softphone 309. PC 304 is adapted to communicate with a conference server 310 of the online conferencing system 300 over a VoIP network 302. Similarly, PC 305 is adapted to communicate with conference server 310 over VoIP network 302. VoIP network 302 comprises a private enterprise intranet in this embodiment to provide more secure connections between the participants.

Online conferencing system 300 includes client conferencing systems 312-313 that are implemented in PC 304 and PC 305, respectively. Client conferencing system 312 includes a conference portal 315 and navigation plug-in software 316. The navigation plug-in software is one embodiment of the document navigation systems 116 and 118 shown in FIG. 1. Client conferencing system 316 includes a conference portal 317 and navigation plug-in software 318.

Conference server 310 includes a policy server 332, a voice mixer 334, and a conference controller 336. Conference controller 336 is adapted to establish and disconnect the conference connections between conference server 310 and participants 306-307. For instance, participants 306-307 may dial a conference bridge number from phones 308-309, respectively, to join the online conference. Conference controller 336 may use Session Initiation Protocol (SIP) or another protocol for establishing the online conference. Voice mixer 334 is adapted to mix together the Real Time Protocol (RTP) voice streams of participants 306-307.

Policy server 332 is an application that runs on conference server 310. Policy server 332 manages the conference policy, which can be used to control the conference via external means other than SIP. For instance, policy server 332 may use a proprietary policy protocol to interact with conference portals 315 and 317 that run on PCs 304-305, respectively, to perform conference-related operations. Policy server 332 is one embodiment of document control system 152 and navigation control system 154 as shown in FIG. 1.

Conference portals 315 and 317 each comprise is a small application that runs on a PC, which is connected to conference server 310 via an internal network or through a VPN (Virtual Private Network). Conference portal 315 and 317 interacts with the policy server 332 to perform conference-related operations. Participants 306-307 may use the conference portals 315 and 317 to join the online conference and monitor the conference status. For example, participant 306 can click on conference portal 315 to connect his/her softphone 308 to the online conference. Also, participant 306 can view the participant list from conference portal 315.

According to features and aspects herein, navigation plug-in software 316 and 318 comprises new plug-in software that is embedded in an operating system, such as Microsoft Office, of PC 104 and 105 to support document navigation. Navigation plug-in software 316, for instance, is automatically downloaded and installed when participant 306 first launches conference portal 315 on the PC 304. Navigation plug-in software 316 is embedded in the operating system to open a document to be shared in read-only mode to protect the document from being edited by the user. Navigation plug-in software 316 is further adapted to detect the navigation instructions from participant 306 and report the navigation instructions to conference portal 315. Navigation plug-in software 316 is further adapted to execute the navigation instructions received from conference portal 315 so that the document being displayed is synchronized among all participants.

According to features and aspects herein, new policies are defined for online collaboration between conference portals 315 and 317 and policy server 332. For instance, the new policies are implemented in conference portal 315 to register participant 306 in the online conference for online collaboration. The new policies are implemented in conference portal 315 to upload or download documents for online collaboration. The new policies are implemented in conference portal 315 to request navigation instructions from policy server 332. The new policies are implemented in conference portal 315 to open a document to be shared by launching the appropriate application with navigation plug-in software 316. The new policies are implemented in conference portal 315 to forward navigation instructions reported by navigation plug-in software 316 to policy server 332. The new policies are implemented in conference portal 315 to forward navigation instructions received from policy server 332 to navigation plug-in software 316.

According to features and aspects herein, policy server 332 is enhanced to support document uploading, storing, and downloading. Policy server 332 is further enhanced to receive the navigation instructions and to broadcast them to all other participants' conference portals. Policy server 332 is further enhanced to manage the navigation control request authorization and ownership. Policy server 332 is further enhanced to support creating, monitoring, and destroying the online collaboration relationship for the duration of each online conference.

The following describes an exemplary scenario of using the online conference service as provided by online conferencing system 300. To begin, participant 306 launches conference portal 315 on PC 304. Conference portal 315 prompts participant 306 to install the navigation plug-in software 316. Responsive to the instructions from participant 306, conference portal 315 downloads navigation plug-in software 316 from policy server 332 and installs navigation plug-in software 316 in the operating system of PC 304. Online collaboration is then ready for use on PC 304. A similar process is performed to install navigation plug-in software 318 on PC 305.

Before or during the online conference, participant 306 uploads a document to conference server 310 through conference portal 315 using a conference bridge number for the online conference. Assume for this embodiment that the document is a PowerPoint document. Conference server 310 saves the document locally for the online conference identified by the conference bridge number.

Participant 306 enters the conference bridge number through conference portal 315 and connects to the online conference via conference portal 315. The online conference is also connected to softphone 308 that runs on PC 304 so that participant 306 can hear conference voice and/or watch a video. Similarly, participant 307 enters the conference bridge number through conference portal 317 and connects to the online conference via conference portal 317. The online conference is also connected to softphone 309 that runs on PC 305 so that participant 307 can hear conference voice and/or watch a video.

Conference portal 317 then checks for online collaboration materials. In this embodiment, a PowerPoint document has been uploaded for collaboration during the online conference. Conference portal 317 then downloads the PowerPoint document. Policy server 332 then adds participant 307 to the collaboration user list. Conference portal 317 launches the corresponding PowerPoint application 322 with the navigation plug-in software 316 embedded to open the PowerPoint document. Participant 307 begins to view the first page of the PowerPoint document while listening to the conference.

Participant 306 begins navigation through the PowerPoint document by clicking the “Slide Show” button in the PowerPoint application 322. Navigation plug-in software 316 detects “Slide Show” instruction in the PowerPoint application 322 and reports the “Slide Show” instruction to conference portal 315. Conference portal 315 then reports the “Slide Show” instruction to policy server 332.

Policy server 332 then broadcasts the “Slide Show” instruction to the other conference portals of the other participants, such as conference portal 317 of participant 307. Conference portal 317 transmits the “Slide Show” instruction to navigation plug-in software 318. Navigation plug-in software 318 then instructs the PowerPoint application 323 on PC 305 to perform a slide show for the PowerPoint document. The PowerPoint application 322 on PC 304 and the PowerPoint application 323 on PC 305 are thus synchronized to display the slide show of the PowerPoint document.

Assume further that participant 306 clicks a mouse to turn to the next page of the PowerPoint document. Navigation plug-in software 316 detects the “Next Page” instruction and reports the “Next Page” instruction to conference portal 315. Conference portal 315 then reports the “Next Page” instruction to policy server 332. Policy server 332 then broadcasts the “Next Page” instruction to the other conference portals of the participants, such as conference portal 317 of participant 307. Conference portal 317 transmits the “Next Page” instruction to navigation plug-in software 318. Navigation plug-in software 318 then instructs the PowerPoint application 323 on PC 305 to display the next page of the PowerPoint document.

During the online conference, participant 307 may request navigation control by clicking the “Get Navigation Control” button or another input through conference portal 317. Responsive to the input from participant 307, conference portal 317 transmits a navigation control request to policy server 332. Policy server 332 permits the request and broadcasts the navigation control change information to all the conference portals. Conference portal 317 then instructs navigation plug-in software 318 to allow navigation control for participant 307.

Assume that participant 307 clicks a mouse to turn to the previous page of the PowerPoint document. Navigation plug-in software 318 detects the “Previous Page” instruction and reports the “Previous Page” instruction to conference portal 317. Conference portal 317 then reports the “Previous Page” instruction to policy server 332. Policy server 332 then broadcasts the “Previous Page” instruction to the other conference portals of the participants, such as conference portal 315 of participant 306. Conference portal 315 transmits the “Previous Page” instruction to navigation plug-in software 316. Navigation plug-in software 316 then instructs the PowerPoint application 322 on PC 304 to display the previous page of the PowerPoint document.

Although specific embodiments were described herein, the scope of the invention is not limited to those specific embodiments. The scope of the invention is defined by the following claims and any equivalents thereof.

We claim:

1. An online conferencing system adapted to provide online collaboration of documents during an online conference, the online conferencing system comprising:
a conference server;
a first client conferencing system adapted to communicate with the conference server to join a first participant in an online conference over a communication network, and to transmit a document to be shared with a second participant of the online conference to the conference server;
the conference server adapted to receive the document, and to transmit the document to the second participant;
the first client conferencing system adapted to launch a first application to open the document to be shared with the second participant, to detect a navigation instruction from the first participant in the first application for navigating through the document, and to transmit the navigation instruction to the conference server; and
the conference server further adapted to receive the navigation instruction, and to transmit the navigation instruction to the second participant.

2. The online conferencing system of claim 1 further comprising:
a second client conferencing system adapted to communicate with the conference server to join the second participant in the online conference, to receive the document from the conference server, to launch a second application to open the document, to receive the navigation instruction from the conference server, and to provide the navigation instruction to the second application to synchronize viewing of the document with the first application of the first participant.

3. The online conferencing system of claim 2 wherein the conference server is further adapted to receive a navigation control request from the second client conferencing system, and to transmit a navigation control command to the second client conferencing system.

4. The online conferencing system of claim 3 wherein:
the second client conferencing system is further adapted to detect another navigation instruction from the second participant in the second application for navigating through the document, and to transmit the other navigation instruction to the conference server;
the conference server is further adapted to receive the other navigation instruction, and to transmit the other navigation instruction to the first participant;
the first client conferencing system is further adapted to receive the other navigation instruction from the conference server, and to provide the other navigation instruction to the first application to synchronize viewing of the document with the second application of the second participant.

5. The online conferencing system of claim 1 wherein the communication network comprises an enterprise intranet.

6. The online conferencing system of claim 1 wherein the first client conferencing system comprises:
a conference portal adapted to communicate with the conference server to join the first participant in the online conference, and to transmit the document to be shared with the second participant to the conference server; and
a document navigation system adapted to launch the first application to open the document to be shared with the second participant, to detect the navigation instruction from the first participant in the first application for navigating through the document, and to transmit the navigation instruction to the conference portal;
the conference portal is further adapted to transmit the navigation instruction to the conference server.

7. The online conferencing system of claim 6 wherein:
the document navigation system is further adapted to launch the first application to open the document in read-only mode.

8. The online conferencing system of claim 6 wherein the document navigation system comprises plug-in software for an operating system.

9. The online conferencing system of claim 2 wherein the second client conferencing system comprises:
a conference portal adapted to communicate with the conference server to join the second participant in the online conference, to receive the document to be shared from the conference server, and to receive the navigation instruction from the conference server; and
a document navigation system adapted to launch the second application to open the document, and to provide the navigation instruction to the second application to navigate through the document.

10. A client conferencing system adapted to provide online collaboration of documents during an online conference, the client conferencing system comprising:
a conference portal adapted to communicate with a conference server to join a participant in an online conference, and to transmit a document to be shared with other participants of the online conference to the conference server; and
a document navigation system adapted to launch an application to open the document to be shared with the other participants, to detect a navigation instruction from the participant in the application for navigating through the document, and to transmit the navigation instruction to the conference portal;
the conference portal is further adapted to transmit the navigation instruction to the conference server.

11. The client conferencing system of claim 10 wherein:
the conference portal is further adapted to receive another navigation instruction from the conference server, and to transmit the navigation instruction to the document navigation system; and
the document navigation system is further adapted to provide the navigation instruction to the application to navigate through the document.

12. The client conferencing system of claim 10 wherein:
the document navigation system is further adapted to launch the application to open the document in read-only mode.

13. The client conferencing system of claim 10 wherein the document navigation system comprises plug-in software for an operating system.

14. A conference server adapted to provide online collaboration of documents during an online conference, the conference server comprising:
a document control system adapted to receive a document from a first participant of an online conference to be shared with at least one second participant of the online conference, and to transmit the document to the at least one second participant; and
a navigation control system adapted to receive a navigation instruction for navigating through the document from the first participant, and to transmit the navigation instruction to the at least one second participant to synchronize viewing of the document among the first participant and the at least one second participant.

15. The conference server of claim 14 wherein the navigation control system is further adapted to:
receive a navigation control request from the at least one second participant;
transmit a navigation control command to the first participant;
receive another navigation instruction for navigating through the document from the at least one second participant; and
transmit the other navigation instruction to the first participant to synchronize viewing of the document among the first participant and the at least one second participant.
